(19) United States
(12) Patent Application Publication
(10) Pub. No.: US 2008/0023298 A1
(43) Pub. Date: Jan. 31, 2008

(54) Conveyor Belt Cleaning Device

(76) Inventor: Emmanuel Davidts, Ecaussines (BE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/596,047

(22) PCT Filed: May 12, 2005
(86) PCT No.: PCT/EP05/52183

§ 371 Date: Nov. 9, 2006

(30) Foreign Application Priority Data
May 13, 2004 (BE) 2004/0243

(51) Int. Cl. B65G 45/00; B65G 45/16; B65G 45/22

(52) U.S. Cl. 198/495; 198/499

(57) ABSTRACT

The invention relates to a cleaning device (1) for frontally or tangentially dressing a conveyor belt (8) comprising a support (2), at least one scraper blade (3) which is rigidly fixed to the support (2) and provided with a cavity (6) extending along the entire width thereof and containing a device (7) for producing a pressure on the scraper blade (3), wherein said pressure device (7) is disposed in such a way that producing pressure it enables the top part (10) of the scraper blade to be rotatably movable in the direction of the conveyor belt (8), the lower part thereof (11) being connected to the stationary support (2).

The present invention relates to a device for cleaning a conveyor belt by frontal or tangential scouring comprising
a support which, in the position of use, is stationary and extends transversely to the longitudinal direction of the conveyor belt,
a scraper blade fixed in a detachable manner on the support, and
a pressure application means capable of applying pressure against the scraper blade.

Conveyor belts are used on many industrial sites such as mines, quarries, iron and steel works, cement works, etc. for transporting products in bulk from one place to another. The transported products can be dry or wet and it is important to have an efficient system for cleaning the conveyor belts during their use.

For this cleaning, there are several systems of the tangential or frontal type. There is known for example a device as indicated at the beginning where the pressure application means is an inflatable air chamber inserted between the scraper blade and a housing made or fixed on the support in order to receive therein the air chamber (see DE-A-19913361). This device therefore requires a support of complex construction, which increases the manufacturing costs.

Devices are also known where one or more cavities are provided in the body of the scraper blade, for increasing its flexibility (see for example U.S. Pat. No. 6,315,105 or DE-U-29503929). In certain cases, a rod of elastic material can be inserted in this cavity, in order to soften the pressure exerted by the belt to be cleaned moving over the scraper blade.

Devices are also known whereof the scraper blade made from flexible and elastic material is shaped so that, under the pressure of the belt to be scraped, it can flex, and then resume its initial rest position when this pressure disappears (see for example EP-0667831).

In all these last aforementioned devices, the means of applying pressure on the scraper blade, so that it is applied correctly and with the required force on the belt to be scraped, consists of a mechanical system making it possible to turn the support about an axis transverse to the longitudinal direction of the conveyor belt. This is because this pressure may have to vary over time and during the first adjustment it may prove to be incorrectly adjusted and require a modification of the position of the scraper blade with respect to the conveyor belt. All these systems are therefore to be adjusted from the outside and require a complex and expensive mechanical construction.

The aim of the present invention is to overcome these drawbacks. For this, the invention provides a cleaning device as indicated at the beginning and in which
the scraper blade has a cavity that extends over the entire width of the scraper blade and is open towards the outside, dividing it into an upper part and a lower part, the upper part being capable of performing a gyratory movement with respect to the lower part connected to the support,
the pressure application means is housed in said cavity, and applies a pressure on the upper part of the scraper blade,
the upper part of the scraper blade has a rest position between two extreme gyration positions, a first extreme gyration position in which it is closer to the lower part than in the rest position and the pressure application means is in a state of compression, and a second extreme gyration position in which it is further away from the lower part than in the rest position and the pressure application means is in a state of expansion.

The device according to the invention offers the great advantage that the pressure application means and the upper part of the scraper blade interact with one another totally independently of the support to which the lower part of the scraper blade is connected. The support is therefore simple in design and easy to manipulate and it no longer has to be moved after the start of the cleaning. Moreover, the upper part of the blade can, in this device according to the invention, not only flex from its rest position under the pressure of the conveyor belt, being assisted by the pressure application means which serves to soften this pressure, but also be displaced from its rest position, in the other direction, towards the belt to be scraped in order to adjust the efficiency of the scraping. These actions are carried out from inside the scraper blade in accordance with a very simple mutual arrangement of the different elements of the device.

According to one embodiment of the invention, the pressure application means is a flexible fluid chamber, which can be connected to a source of fluid under pressure.

This system offers an adjustment flexibility that requires only inflation or deflation of a fluid chamber, without having to resort to complex mechanical devices. The upper part of the scraper blade moves, independently of the support which remains fixed, in the direction of the conveyor belt under the pressure exerted by the fluid chamber.

The fluid used is advantageously air, or any other gas or gaseous mixture, or a liquid or liquid mixture. The fluid pressure can be modified very easily, with no great labour intervention. For this, any means whatsoever of adjusting the pressure of a fluid inside a fluid chamber can be used, for example a pump, a compressor, etc.

Another advantage of the present invention is that the scraper blade is clipped onto the support. This is because, in order to provide the maintenance of this conveyor belt cleaning device, the user does not need any tool. He just needs to stop the conveyor belt for the time to unclip the blade, replace it and restart the conveyor belt.

The scraper blade used with the conveyor belt cleaning device of the invention preferably consists of segments of blades fixed side by side preferably by clipping and independently of one another on the support. Thus, the accuracy of the scraping is increased since the segments move independently of one another with no risk of catching on the conveyor belt and damaging it. Furthermore, when a blade segment is worn or damaged, it can be replaced independently of the other segments, which is more economical and very easy to carry out.

In one of the embodiments of the conveyor belt cleaning device of the invention, the scraper blade is manufactured from an elastic material.

This makes it possible to scrape the conveyor belt in an optimal manner since the flexibility of the scraper blade makes it possible to adapt perfectly to the profile of the conveyor belt.

In a separate embodiment, the scraper blade is manufactured at least partially from a rigid material.

Any appropriate pressure application means other than an air chamber can obviously be provided. Cylinder-based or solenoid-based systems among others can for example be conceived.

Other details and particular features of the invention will emerge from the description given below, on a non-limiting basis, and with reference to the accompanying drawings.

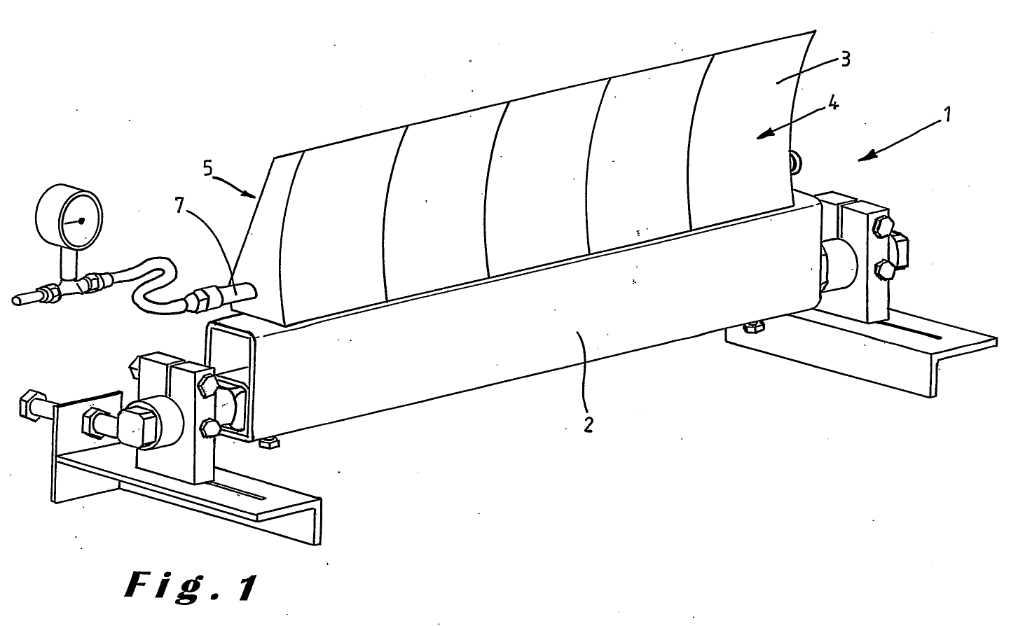

FIG. 1 is a perspective view of a conveyor belt cleaning device according to the invention.

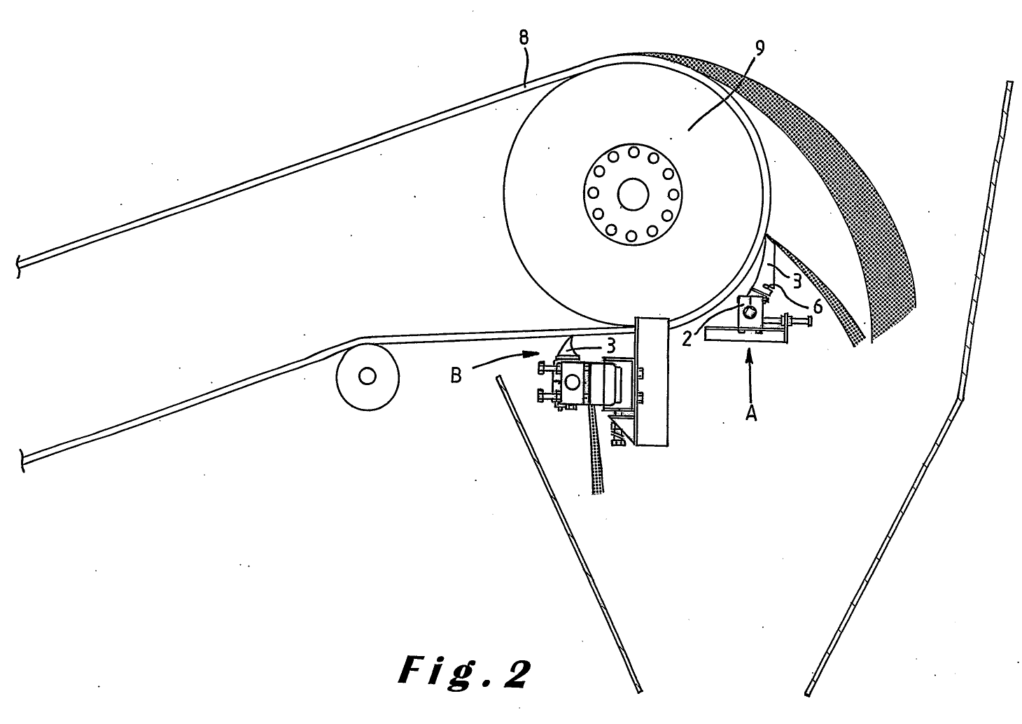

FIG. 2 illustrates the frontal position and the sub-adjacent position of a conveyor belt cleaning device according to the invention, with respect to a conveyor belt.

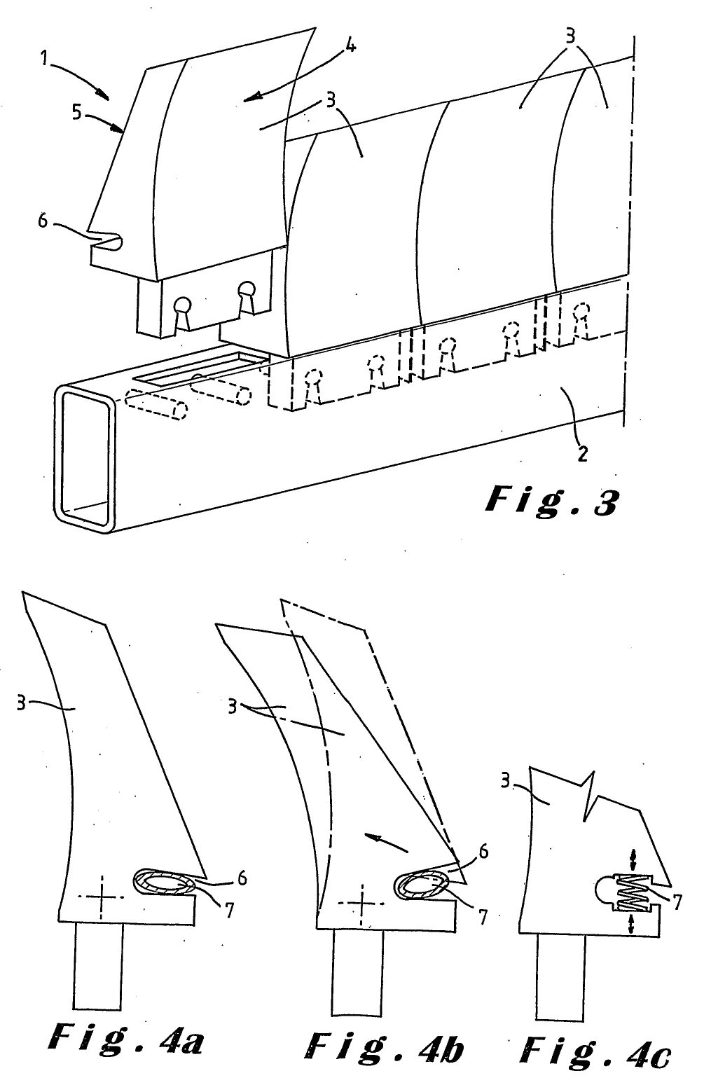

FIG. 3 illustrates the method of fixing the conveyor belt cleaning blade on the support.

FIGS. 4a to 4c illustrate the scraper blade with the upper part thereof in its rest position and its two extreme gyration positions.

In a preferred embodiment, the device 1 for cleaning a conveyor belt 8 according to the invention comprises a metal support 2 over the entire length of which a set of scraper blade segments 3 is disposed. These scraper blade segments 3 have a front face 4 facing the conveyor belt and a rear face 5. They are provided with a cavity 6 which is disposed on their rear face 5 and over their entire width, and which is open towards the outside. This cavity divides the segments of the scraper blade 3 into two parts, an upper part 10 and a lower part 11. The upper part 10 is capable of performing a gyratory movement with respect to the lower part 11 connected to the support 2, which, in the position of use, remains stationary. In the above-mentioned cavity 6 there is inserted a device for applying pressure which is preferably an air chamber 7. This air chamber 7 is connected to a compressed air source (not illustrated) and the pressure is adjustable by ordinary pressure adjustment means which are controllable, for example by manometer.

In general terms, there are two possible positions for a conveyor belt cleaning device. These are illustrated in FIG. 2.

In the sub-adjacent position B, the sub-adjacent conveyor belt cleaning device has the advantage that the conveyor belt is under tension and substantially straight and yet flexible at approximately 10 cm from the outgoing point.

In the frontal position A, the advantage is that the product scraped at this place by the device for cleaning the conveyor belt 8 is tipped directly into the discharge of the transported product. However, it is difficult to adequately scrape the product from the conveyor belt 8 in the frontal position. This is because there are forces in opposition, the conveyor belt 8 is compressed against the barrel of the drum 9 and has no flexibility. These constraints make frontal scraping very difficult.

The device 1 for cleaning a conveyor belt 8 of the invention overcomes all these problems by virtue of the combination of various elements. The device for applying pressure inserted over the entire length of the scraper blade 3 and at its rear face makes it possible to apply a constant and balanced pressure.

Moreover, the segmented scraper blade 3 makes it possible to refine the application of the pressure and to scrape the conveyor belt 8 smoothly. This smoothness is also greater due to the fact that the scraper blade 3 is itself made from elastic material. Thus, the contact of the scraper blade 3 with the conveyor belt 8 is flexible and precise, and all the deformations present on the conveyor belt 8, as well as the joins, perforations, and the presence of metal staples, are absorbed during passage over the scraper blade 3.

The inflating structure 7 inserted in the cavity 6 of the scraper blade 3 is filled with air by means of a pump or the air is stored in a portable reservoir. The pressure of the air is from 1 to 6 bar according to the size of the device 1 for cleaning a conveyor belt 8 and the nature of the product to be scraped from the conveyor belt 8.

In another embodiment, the scraper blade 3 of the device 1 for cleaning a conveyor belt 8 of the invention can be provided, at its end in contact with the conveyor belt 8, with inserts made from sintered aluminium or other materials according to the field of application envisaged. The blade can be flexible or rigid.

In the device 1 for cleaning a conveyor belt 8 of the invention, as illustrated in FIG. 3, the scraper blade segments 3 are fixed on the metal support 2 without resorting to fixing means requiring a tool. This is because, as illustrated in FIG. 3, the scraper blade 3, whether it is whole or segmented, is clipped onto the support 2.

In a preferential embodiment, the scraper blade 3 consists of segments independent of one another and clipped side by side on the support 2. This allows easy removal of materials while avoiding clogging of products whilst facilitating the maintenance of the device 1 for cleaning a conveyor belt 8 since all that is needed is to unclip the worn or damaged blade segment 3, without using any tool, and to replace it without having to undo the other segments.

Moreover, the wear of the scraper blade 3 is compensated for automatically with the device 1 for cleaning a conveyor belt 8 of the invention by virtue of the air chamber 7 which extends over the entire length of the scraper blade 3 and therefore provides a constant and well-distributed pressure on the conveyor belt 8. This controlled pressure makes it possible to use the device 1 for cleaning a conveyor belt 8 with conveyor belts 8 which are damaged, stapled or mechanically assembled while providing highly efficient scouring of such conveyor belts 8.

The form of the device 1 for cleaning a conveyor belt 8 of the invention makes it compact and facilitates the flow of scraped products whilst guaranteeing perfect sealing.

FIGS. 4a to 4c illustrate the gyratory movement that a scraper blade 3 of the device 1 for cleaning a conveyor belt 8 of the invention can carry out. FIG. 4a shows the upper part 10 of the blade 3 in the rest position. When pressure is exerted by inflation of the air chamber 7 disposed in the cavity 6 of the scraper blade 3 (expansion position), the upper part 10 performs a gyratory movement in the direction of the arrow illustrated in FIG. 4b, with inclination towards the front of the scraper blade 3, which provides optimal contact with the conveyor belt 8 that has to be scraped. The flexibility of the scraper blade 3 due to its elastic material also contributes towards better contact and compensation for contour irregularities of the conveyor belt 8 to be scraped.

Under the effect of pressure exerted by the conveyor belt, the upper part 10 of the blade can be driven in a gyratory movement in the direction of the arrow illustrated in FIG. 4c. In this position, the air chamber is squeezed between the upper part 10 and the lower part 11 (compression state) and the air chamber therefore softens the effects of this pressure.

It can also be seen in FIGS. 4a to 4c that the scraper blade 3 performs a movement that entails no movement of the support itself. This is because the interaction between the upper part 10 of the scraper blade 3 and the air chamber 7 is independent of the support 2 which remains completely inert and in no way participates in this interaction.

1. Device (1) for cleaning a conveyor belt (8) by frontal or tangential scouring comprising
a support (2) which, in the position of use, is stationary and extends transversely to the longitudinal direction of the conveyor belt (8),
a scraper blade (3) fixed in a detachable manner on the support (2), and
a pressure application means (7) capable of applying pressure against the scraper blade,
wherein
the scraper blade (3) has a cavity (6) that extends over the entire width of the scraper blade and is open towards the outside, dividing it into an upper part (10) and a lower part (11), the upper part being capable of performing a gyratory movement with respect to the lower part connected to the support,
the pressure application means (7) is housed in said cavity (6) and applies a pressure on the upper part (10) of the scraper blade (3),
the upper part (10) of the scraper blade has a rest position between two extreme gyration positions, a first extreme gyration position in which it is closer to the lower part (11) than in the rest position and the pressure application means (7) is in a state of compression, and a second extreme gyration position in which it is further away from the lower part than in the rest position and the pressure application means (7) is in a state of expansion.

2. Device (1) according to claim 1, wherein the pressure application means (7) is a flexible fluid chamber which can be connected to a source of fluid under pressure.

3. Device (1) for cleaning a conveyor belt (8) according to claim 1, wherein the scraper blade (3) is clipped onto the support (2).

4. Device according to claim 2, including means of adjusting the pressure of the fluid inside the fluid chamber.

5. Device (1) for cleaning a conveyor belt (8) according to claim 1, wherein the scraper blade (3) consists of blade segments fixed side by side and independently of one another on the support (2).

6. Device (1) for cleaning a conveyor belt (8) according to claim 1, wherein the scraper blade (3) is made at least partially from an elastic material.

7. Device (1) for cleaning a conveyor belt (8) according to claim 1, wherein the scraper blade (3) is made at least partially from a rigid material.

8. Device according to claim 2, wherein the fluid is a gas, a liquid or a gaseous or liquid mixture, such as air.

9. Use of a cleaning device (1) according to claim 1 for the frontal, tangential or sub-adjacent scouring of a conveyor belt (8).
